(19) United States
(12) Patent Application Publication
(10) Pub. No.: US 2026/0118834 A1
(43) Pub. Date: Apr. 30, 2026

(54) APPARATUS, SYSTEM, AND METHOD FOR RESTORING DISABLED FUNCTIONALITIES OF APPLIANCES UPON MITIGATING CORRESPONDING SAFETY CONCERNS

(71) Applicant: FireAvert, LLC, Springville, UT (US)

(72) Inventors: Peter Thorpe, Springville, UT (US); Larsen Alma Webb, Springville, UT (US); Dallin Woodbrey, Springville, UT (US)

(73) Assignee: FireAvert, LLC, Springville, UT (US)

(21) Appl. No.: 19/323,951

(22) Filed: Sep. 9, 2025

Related U.S. Application Data
(60) Provisional application No. 63/711,804, filed on Oct. 25, 2024.

(51) Int. Cl. G05B 9/02; G01M 99/00

(52) U.S. Cl. CPC G05B 9/02; G01M 99/008

(57) ABSTRACT

A disclosed system for restoring disabled functionalities of appliances upon mitigating corresponding safety concerns includes and/or involves a microphone, a regulator device, and/or circuitry. The regulator device modifies a functionality of an appliance in response to the detection of a specific sound captured by the microphone. Additionally or alternatively, the circuitry (1) determines, based at least in part on a signal received from the microphone, that the specific sound is no longer audible a certain amount of time after the regulator device modifies the functionality of the appliance and/or (2) restore the functionality of the appliance in response to the specific sound no longer being audible. Various other apparatuses, systems, and methods are also disclosed.

### CROSS REFERENCE TO RELATED APPLICATION

This application claims the benefit of U.S. Provisional Application No. 63/711,804 filed Oct. 25, 2024, the disclosure of which is incorporated in its entirety by this reference.

### BACKGROUND

Smoke alarms are often used to warn occupants of a fire. For example, a smoke alarm may detect the presence of smoke emitted by a fire and then produce an alarm signal in response to the detected smoke. In some cases, regulator devices may be deployed to automatically disable certain functionalities of appliances in response to the alarm signal produced by the smoke alarm. These regulator devices, however, may leave the functionalities disabled long after the fire and corresponding smoke have dissipated. Unfortunately, some users of such regulator devices may be unaware of how to restore the disabled functionalities of the appliances. The instant disclosure, therefore, identifies and addresses a need for additional and improved apparatuses, systems, and methods for restoring disabled functionalities of appliances upon mitigating corresponding safety concerns (e.g., fire hazards).

### SUMMARY

As will be described in greater detail below, the instant disclosure generally relates to systems and methods for restoring disabled functionalities of appliances upon mitigating corresponding safety concerns. In one example, a system for restoring disabled functionalities of appliances upon mitigating corresponding safety concerns includes and/or involves a microphone, a regulator device, and/or circuitry. In this example, the regulator device modifies a functionality of an appliance in response to the detection of a specific sound captured by the microphone. Additionally or alternatively, the circuitry (1) determines, based at least in part on a signal received from the microphone, that the specific sound is no longer audible a certain amount of time after the regulator device modifies the functionality of the appliance and/or (2) restores the functionality of the appliance in response to the specific sound no longer being audible.

In another example, a corresponding apparatus includes and/or involves a microphone, a regulator device, and/or circuitry. In this example, the regulator device disables a resource of an appliance in response to the detection of a specific sound captured by the microphone. Additionally or alternatively, the circuitry (1) determines, based at least in part on a signal received from the microphone, that the specific sound is no longer audible a certain amount of time after the regulator device disables the resource of the appliance and/or (2) restores the functionality of the appliance in response to the specific sound no longer being audible.

Additionally or alternatively, a corresponding method includes and/or involves (1) configuring a regulator device to modify a functionality of an appliance in response to detection of a specific sound captured by a microphone and (2) configuring circuitry to (A) determine, based at least in part on a signal received from the microphone, that the specific sound is no longer audible a certain amount of time after the regulator device modifies the functionality of the appliance and (B) restore the functionality of the appliance in response to the specific sound no longer being audible.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an exemplary apparatus for restoring disabled functionalities of appliances upon mitigating corresponding safety concerns in accordance with one or more embodiments of this disclosure.

FIG. 2 is an illustration of an exemplary implementation of a system for restoring disabled functionalities of appliances upon mitigating corresponding safety concerns in accordance with one or more embodiments of this disclosure.

FIG. 3 is an illustration of an exemplary implementation of a system for restoring disabled functionalities of appliances upon mitigating corresponding safety concerns in accordance with one or more embodiments of this disclosure.

FIG. 4 is an illustration of an exemplary implementation of a system for restoring disabled functionalities of appliances upon mitigating corresponding safety concerns in accordance with one or more embodiments of this disclosure.

FIG. 5 is an illustration of an exemplary implementation of a system for restoring disabled functionalities of appliances upon mitigating corresponding safety concerns in accordance with one or more embodiments of this disclosure.

FIG. 6 is a flow diagram of an exemplary method for restoring disabled functionalities of appliances upon mitigating corresponding safety concerns in accordance with one or more embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure describes apparatuses, systems, and methods for restoring disabled functionalities of appliances upon mitigating corresponding safety concerns. For example, many people who own electric and/or gas stoves may be unaware of how to reboot and/or power cycle the electric and/or gas stoves after being shut off and/or disabled by regulator devices. In this example, the regulator devices may monitor environments and/or dwellings for auditory smoke alarms and then disable electricity and/or gas flow to the connected stoves as a safety measure and/or precaution. However, once the fire or the cause of the smoke dissipates, the owners of the stoves may be unable to restore the electricity and/or gas flow to their stoves in a safe way.

As a specific example, a smart power regulator (e.g., equipped with a switch and/or relay) applied to and/or installed onto an electric device (e.g., an electric stove, electric oven, etc.) within a dwelling. In this example, the smart power regulator may be designed and/or intended to detect the presence of a fire by monitoring the dwelling for a sound pattern and/or sequence of a smoke alarm indicative of a fire. In response to detecting a fire in the dwelling, the power regulator may automatically disable, interrupt, and/or shut down the flow and/or delivery of electricity to the electric device. By doing so, the power regulator may be able to mitigate, abate, and/or address potential fire hazards associated with the electric device.

Continuing with this example, the power regulator may monitor the status of the smoke alarm to determine when the fire has dissipated and/or been handled. For example, the power regulator may detect the moment in time that the smoke alarm stops producing the sound pattern and/or sequence indicative of a fire. By doing so, the power regulator may be able to determine when the electric device is considered safe to operate again after the fire.

In one example, the power regulator may provide a test signal (e.g., an electric pulse) to the electric device to measure its current draw and/or power load via a current sensor before making a determination on the electric device's safety. For example, if the electric device draws an excessive amount of electric current from the test signal, then the circuitry may determine that the electric device is still unsafe and thus unfit to have the electricity restored for one reason or another (e.g., one or more control knobs are set to the “on” position). However, if the electric device draws an acceptable amount of electric current from the test signal, then the circuitry may determine that the electric device is safe and thus fit to have the electricity restored (e.g., all control knobs are set to the “off” position). In this example, upon determining that the electric device is safe in this way, the circuitry may restore the flow and/or delivery of electricity to the electric device via the power regulator, thereby reenabling the electric device for further use.

As another example, a smart gas regulator (e.g., equipped with an electric solenoid, actuator, and/or valve) applied to and/or installed onto a gas device (e.g., a gas stove, gas oven, etc.) within a dwelling. In this example, the smart gas regulator may be designed and/or intended to detect the presence of a fire by monitoring the dwelling for a sound pattern and/or sequence of a smoke alarm indicative of a fire. In response to detecting a fire in the dwelling, the gas regulator may automatically disable, interrupt, and/or shut down the flow and/or delivery of gas to the gas device. By doing so, the gas regulator may be able to mitigate, abate, and/or address potential fire hazards associated with the gas device.

Continuing with this example, the gas regulator may monitor the status of the smoke alarm to determine when the fire has dissipated and/or been handled. For example, the gas regulator may detect the moment in time that the smoke alarm stops producing the sound pattern and/or sequence indicative of a fire. By doing so, the gas regulator may be able to determine when the gas device is considered safe to operate again after the fire.

In one example, the gas regulator may provide a test load (e.g., a gas pulse) to the gas device to inspect (e.g., via a flow meter) whether the gas device is configured and/or activated to draw any gas before making a determination on the gas device's safety. Additionally or alternatively, the gas regulator may measure the amount of pressure within a gas line or connection (e.g., via a pressure sensor) to infer whether the gas device is configured and/or activated to draw any gas before making a determination on its safety. For example, if the gas device is configured and/or activated to draw any gas, then the circuitry may determine that the gas device is still unsafe and thus unfit to have the gas restored for one reason or another (e.g., one or more control knobs are set to the “on” position). However, if the gas device is not configured and/or activated to draw any gas, then the circuitry may determine that the gas device is safe and thus fit to have the gas restored (e.g., all control knobs are set to the “off” position). In this example, upon determining that the gas device is safe in this way, the circuitry may restore the flow and/or delivery of gas to the gas device via the gas regulator, thereby reenabling the gas device for further use.

As a further example, a smart power regulator (e.g., equipped with a relay and/or switching mechanism) may be applied to and/or installed onto an industrial machine (e.g., a lathe, wheel grinder, or other electrically powered equipment) within a commercial or industrial setting. In this example, the smart power regulator may be designed and/or intended to detect the presence of a fire by monitoring the environment for a sound pattern and/or sequence of a smoke alarm indicative of a fire. In response to detecting a fire in the environment, the power regulator may automatically disable, interrupt, and/or shut down the flow and/or delivery of electricity to the industrial machine. By doing so, the power regulator may be able to mitigate, abate, and/or address potential fire hazards associated with the industrial machine.

Continuing with this example, the power regulator may monitor the status of the smoke alarm to determine when the fire has dissipated and/or been handled. For example, the power regulator may detect the moment in time that the smoke alarm stops producing the sound pattern and/or sequence indicative of a fire. By doing so, the power regulator may be able to determine when the industrial machine is considered safe to operate again after the fire.

In one example, the power regulator may perform a continuity test across the output terminals of the relay or switching mechanism while the machine remains disconnected from power. The continuity test may be used to determine whether the industrial machine's own power switch is still in the “on” position. For example, if the continuity test indicates that the circuit is closed (e.g., the machine's power switch is “on”), then the circuitry may determine that the industrial machine is still unsafe and thus unfit to have electricity restored for one reason or another (e.g., the machine would immediately start operating upon restoration of power). However, if the continuity test indicates that the circuit is open (i.e., the machine's power switch is “off”), then the circuitry may determine that the industrial machine is safe and thus fit to have electricity restored. In this example, upon determining that the industrial machine is safe in this way, the circuitry may restore the flow and/or delivery of electricity to the industrial machine via the power regulator, thereby reenabling the machine for further use.

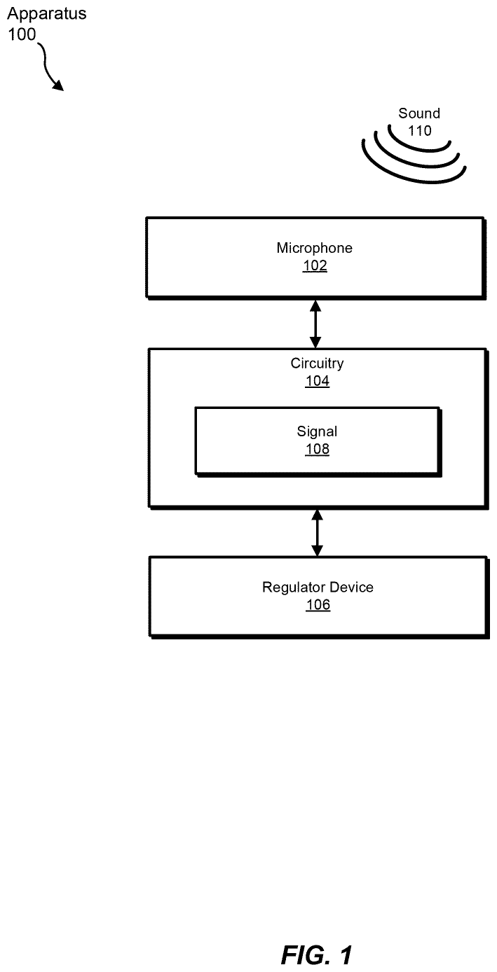

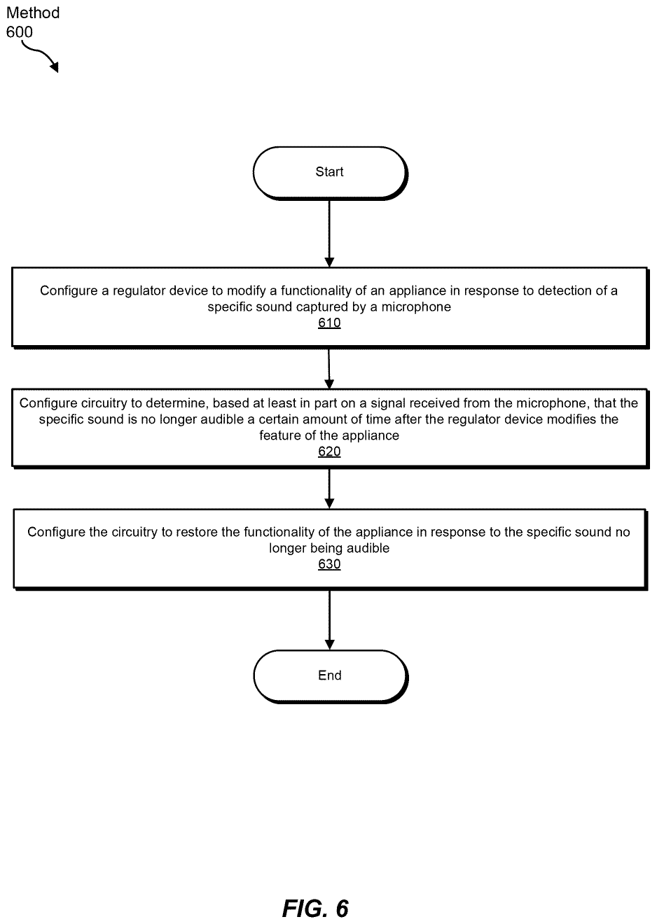

The following will provide, with reference to FIGS. 1-5, detailed descriptions of exemplary apparatuses, systems, devices, and corresponding implementations for restoring disabled functionalities of appliances upon mitigating corresponding safety concerns. Detailed descriptions of an exemplary method for restoring disabled functionalities of appliances upon mitigating corresponding safety concerns will be provided in connection with FIG. 6.

FIG. 1 illustrates an exemplary apparatus 100 capable of restoring disabled functionalities of appliances upon mitigating corresponding safety concerns. As illustrated in FIG. 1, exemplary apparatus 100 may include and/or represent a microphone 102, circuitry 104, and/or a regulator device 106. In some examples, apparatus 100 may constitute and/or represent a smart regulator device that includes microphone 102 and/or circuitry 104. For example, although illustrated as discrete units in FIG. 1, regulator device 106 may include and/or represent microphone 102 and/or circuitry 104. Additionally or alternatively, circuitry 104 may be communicatively and/or electrically coupled to microphone 102 and/or regulator device 106.

In some examples, regulator device 106 may be configured to modify, suspend, and/or disable a functionality or resource of an appliance in response to the detection of a sound 110 captured by microphone 102. In one example, circuitry 104 may receive and/or detect a sound signal 108 corresponding to and/or representative of sound 110 from microphone 102. In this example, circuitry 104 may recognize, identify, and/or detect a certain pattern, signature, and/or sequence indicative of a smoke and/or fire alarm within sound signal 108. In other words, circuitry 104 may determine and/or conclude that a smoke and/or fire alarm is beeping and/or blaring based at least in part on the pattern, signature, and/or sequence detected within sound signal 108.

In some examples, in response to determining that the smoke and/or fire alarm is beeping and/or blaring, circuitry 104 may direct and/or cause regulator device 106 to suspend, disable, and/or shut off a certain functionality and/or resource of the appliance (e.g., the flow and/or delivery of electricity and/or gas, etc.) for safety reasons. In one example, circuitry 104 may be configured to determine that the sound 110 is no longer audible a certain amount of time after regulator device 106 suspends and/or disables the functionality or resource of the appliance. For example, circuitry 104 may check whether sound 110 is still audible two, five, ten, and/or thirty minutes after regulator device 106 suspends and/or disables the functionality or resource of the appliance. In this example, if sound 110 is no longer audible after the certain amount of time expires, circuitry 104 may restore the functionality and/or resource of the appliance. However, in certain implementations, if sound 110 is still audible after the certain amount of time expires, circuitry 104 may refuse to restore the functionality and/or resource of the appliance and may lock the restore feature to prevent auto-restoration and/or force a manual reboot by a user (e.g., via a button, switch, user interface, etc.).

In some examples, circuitry 104 may restore the functionality and/or resource of the appliance by rebooting the appliance in response to and/or due at least in part to sound 110 no longer being audible. For example, circuitry 104 may send and/or transmit a reboot signal to the appliance to initiate a reboot. In this example, the reboot may cause the appliance to regain the functionality and/or resource that was suspended and/or disabled by regulator device 106.

In other examples, circuitry 104 may restore the functionality and/or resource of the appliance by rebooting regulator device 106 in response to and/or due at least in part to sound 110 no longer being audible. For example, circuitry 104 may send and/or transmit a reboot signal to regulator device 106 to initiate a reboot. In this example, the reboot may cause regulator device 106 to restore the functionality and/or resource that was previously suspended and/or disabled.

In some examples, circuitry 104 may determine that sound 110 is still audible a certain amount of time after regulator device 106 suspends and/or disables the functionality or resource of the appliance. For example, circuitry 104 may check whether sound 110 is still audible two, five, ten, and/or thirty minutes after regulator device 106 suspends and/or disables the functionality or resource of the appliance. In this example, if sound 110 is no longer audible after the certain amount of time expires, circuitry 104 may restore the functionality and/or resource of the appliance.

In some examples, regulator device 106 may modify the functionality of the appliance by shutting down and/or turning off gas flow to the appliance. In other examples, regulator device 106 may modify the functionality of the appliance by shutting down and/or turning off electricity flow (e.g., electric current) to the appliance. In certain implementations, circuitry 104 may direct, cause, and/or instruct regulator device 106 to perform such modifications to the functionality of the appliance.

In some examples, circuitry 104 may include and/or represent one or more electrical and/or electronic circuits capable of processing, applying, modifying, transforming, displaying, transmitting, receiving, and/or executing data for apparatus 100. In one example, circuitry 104 may access and/or analyze data stored in one or more storage devices to facilitate and/or support restoring disabled functionalities of appliances upon mitigating corresponding safety concerns. Additionally or alternatively, circuitry 104 may launch, perform, and/or execute certain executable files, code snippets, and/or computer-readable instructions to facilitate and/or support restoring disabled functionalities of appliances upon mitigating corresponding safety concerns.

Although illustrated as a single unit in FIG. 1, circuitry 104 may include and/or represent a collection of multiple processing units and/or electrical or electronic components that work and/or operate in conjunction with one another. In one example, circuitry 104 may include and/or represent one or more application-specific integrated circuits (ASICs). Additionally or alternatively, circuitry 104 may include and/or represent one or more central processing units (CPUs) and/or graphics processing units (GPUs). Additional examples of circuitry 104 include, without limitation, processing devices, microprocessors, microcontrollers, controllers, field-programmable gate arrays (FPGAs), systems on chips (SoCs), parallel accelerated processors, tensor cores, integrated circuits, chiplets, receivers, transmitters, transceivers, storage devices, memory devices, caches, logical circuitry, analog circuitry, sensors (e.g., pressure sensors, current sensors, etc.), meters, portions of one or more of the same, variations or combinations of one or more of the same, and/or any other suitable circuitry.

In some examples, circuitry 104 may be distributed across multiple devices and/or multiple locations. For example, circuitry 104 may include and/or represent one or more circuits implemented and/or deployed at the site of the appliance. Additionally or alternatively, circuitry 104 may include and/or represent one or more circuits implemented and/or deployed at a remote site of a server that communicates with the appliance (e.g., via network).

In some examples, regulator device 106 may include and/or represent any type of form of device, component, and/or mechanism capable of modifying, terminating, suspending, disabling, restoring, enabling, and/or reenabling one or more functionalities and/or resources of an appliance. Examples of regulator device 106 include, without limitation, power switches, electronic switches, relays, motorized breakers, contactors, electric solenoids, actuators, controllable valves, combinations or variations of one or more of the same, and/or any other suitable regulator devices.

In some examples, the functionalities and/or resources of the appliance may include and/or represent any potentially dangerous features that could cause and/or exacerbate a fire and/or smoke event or lead to additional damage. For example, the functionality or resource of an electric device may include and/or represent the use and/or flow of electricity, which could potentially cause and/or exacerbate a fire and/or smoke event. Additionally or alternatively, the functionality or resource of an electric stove may include and/or represent a heating element (e.g., stovetop coil, etc.) that generates heat, which could potentially cause and/or exacerbate a fire and/or smoke event. In another example, the functionality or resource of a gas device may include and/or represent the use and/or flow of gas, which could potentially cause and/or exacerbate a fire and/or smoke event. Additionally or alternatively, the functionality or resource of a gas stove may include and/or represent a heating element (e.g., stovetop burner, etc.) that generates heat and/or a burner flame, which could potentially cause and/or exacerbate a fire and/or smoke event.

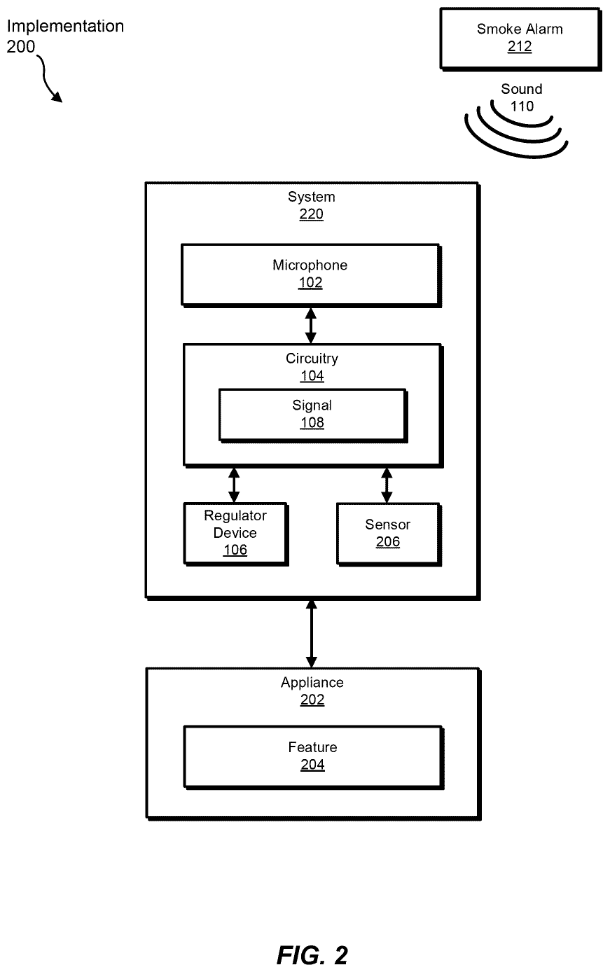

FIG. 2 illustrates an exemplary implementation 200 of a system 220 for restoring disabled functionalities of appliances upon mitigating corresponding safety concerns. In some examples, implementation 200 may include and/or represent certain mechanisms, components, devices, and/or features that perform and/or provide functionalities that are similar and/or identical to those described above in connection with FIG. 1. In one example, system 220 may include and/or represent microphone 102, circuitry 104, regulator device 106, and/or sensor 106. In this example, system 220 may be deployed and/or implemented in an environment (e.g., a dwelling, residential housing, commercial building, industrial building, retail building, government building, etc.) with an appliance 202 and/or a smoke alarm 212. In certain implementations, smoke alarm 212 may generate, emit, and/or produce sound 110, which causes and/or leads to regulator device 106 modifying the functionality and/or resource of appliance 202.

In some examples, system 220 may be coupled to appliance 202 in one way or another. For example, regulator device 106 of system 220 may be electrically coupled to appliance 202. In this example, regulator device 106 of system 220 may be able to control and/or regulate the flow of electricity, power, and/or current between a power outlet and appliance 202. In another example, regulator device 106 of system 220 may be fluidically coupled to appliance 202. In this example, regulator device 106 of system 220 may be able to control and/or regulate the flow of gas, liquid, and/or fluid between a corresponding source and appliance 202.

In some examples, circuitry 104 of system 220 may test whether a potentially dangerous feature 204 of appliance 202 is turned on. For example, circuitry 104 of system 220 may perform a test to determine whether one or more control knobs, switches, and/or buttons are turned on and/or set to the “on” position. In this example, such control knobs, switches, and/or buttons may be potentially dangerous because they control whether electricity and/or gas is transferred, passed, and/or provided to appliance 202 for generating heat and/or fire. As will be explained in greater detail below, the test may be performed in a variety of ways (e.g., measuring the amount of current drawn by appliance 202 from an electric test pulse, measuring the amount of pressure on a gas line, etc.) depending on the type of appliance involved.

In some examples, circuitry 104 of system 220 may determine that the potentially dangerous feature is turned off and/or is not turned on based at least in part on the test. For example, circuitry 104 of system 220 may compare the amount of current drawn by appliance 202 to a threshold value indicative of potentially dangerous feature 204 being turned on. In another example, circuitry 104 of system 220 may compare the amount of gas flow drawn by appliance 202 to a threshold value indicative of potentially dangerous feature 204 being turned on (e.g., any gas flow at all).

In some examples, circuitry 104 of system 220 may restore the functionality and/or resource of appliance 202 due at least in part to potentially dangerous feature 204 being turned off and/or not being turned on. In other examples, circuitry 104 of system 220 may determine that potentially dangerous feature 204 is turned on and/or is not turned off based at least in part on the test. In one example, circuitry 104 of system 220 may refuse to restore the functionality and/or resource of appliance 202 due at least in part to potentially dangerous feature 204 being turned on and/or not being turned off. In this example, circuitry 104 of system 220 may lock the auto-restoration mechanism such that a user is forced to perform a manual reboot of appliance 202, regulator device 106, and/or system 220 to restore the functionality and/or resource of appliance 202.

In some examples, appliance 202 may include and/or represent one or more electric devices that consume electricity and/or power. In other examples, appliance 202 may include and/or represent one or more gas devices that consume gas. Examples of appliance 202 include, without limitation, electric stoves, electric ovens, lathes, grinders, cooking devices, heat-generating devices, gas stoves, gas ovens, other kitchen appliances (e.g., deep fryers, cooktops, etc.), laundry appliances (e.g., dryers, etc.), other household appliances (e.g., space heaters, water heaters, furnaces, boilers, etc.), manufacturing equipment, combinations of one or more of the same, and/or any other suitable appliances.

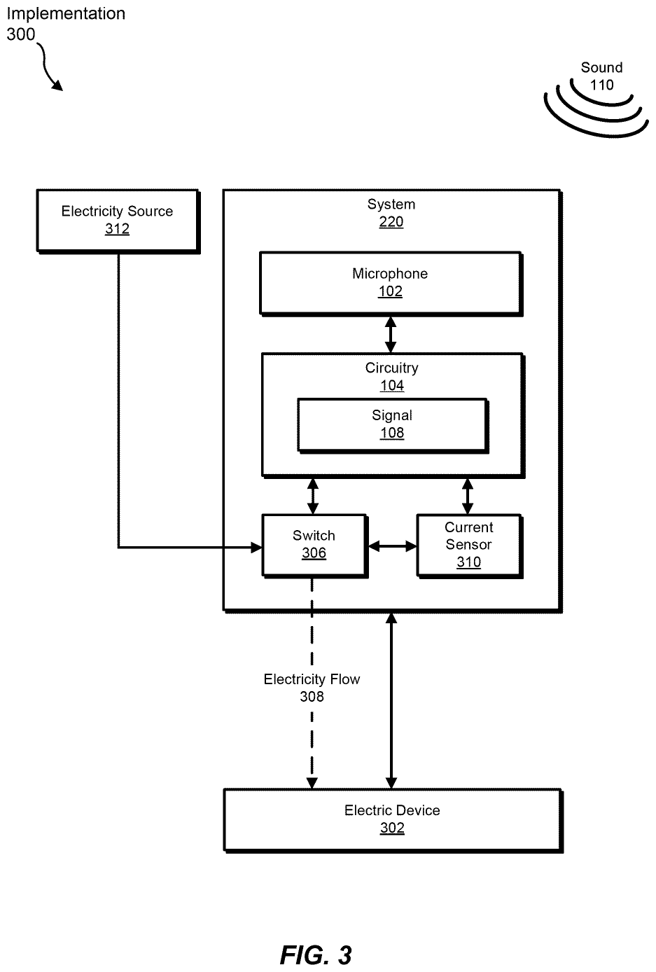

FIG. 3 illustrates an exemplary implementation 300 of system 220 for restoring disabled functionalities of appliances upon mitigating corresponding safety concerns. In some examples, system 220 may include and/or represent certain mechanisms, components, devices, and/or features that perform and/or provide functionalities that are similar and/or identical to those described above in connection with either FIG. 1 or FIG. 2. In one example, system 220 may include and/or represent microphone 102, circuitry 104, a switch 306, and/or a current sensor 310. In this example, system 220 may be deployed and/or implemented in an environment with an electric device 302 and/or an electricity source 312.

In some examples, system 220 may be electrically and/or communicatively coupled to electric device 302 via a conductive cable and/or power line. For example, switch 306 of system 220 may be electrically coupled to electric device 302. In this example, switch 306 of system 220 may be able to control and/or regulate the flow of electricity, power, and/or current between a power outlet and electric device 302.

In some examples, current sensor 310 may be electrically and/or communicatively coupled to switch 306 and/or to the conductive cable or power line to facilitate and/or support measuring the amount of current that electric device 302 is configured to draw from electricity source 312 if electricity were to be restored to electric device 302. In one example, current sensor 310 may measure and/or determine the amount of current that is drawn by appliance 202 by providing a test signal (e.g., an electric pulse) to appliance 202 prior to fully restoring the power connection between electric device 302 and electricity source 312. For example, circuitry 104 of system 220 may compare the amount of current drawn by appliance 202 to a threshold value (e.g., any current at all, a small amount of current, a large amount of current, etc.) indicative of the potentially dangerous feature being turned on.

In one example, if electric device 302 draws an excessive amount of electric current from the test signal, then circuitry 104 of system 220 may determine that electric device 302 is still unsafe and thus unfit to have the power restored for one reason or another (e.g., one or more control knobs of electric device 302 are set to an “on” position). For example, if a lathe is drawing any current above zero amps, then circuitry 104 of system 220 may determine that the lathe is still unsafe and thus unfit to have the power restored. However, if electric device 302 draws an acceptable amount of electric current from the test signal, then circuitry 104 of system 220 may determine that electric device 302 is safe and thus fit to have the power restored (e.g., all control knobs of electric device 302 are set to the “off” position). In this example, upon determining that electric device 302 is safe in this way, circuitry 104 may restore an electricity flow 308 to electric device 302 via switch 306, thereby reenabling electric device 302 for further use.

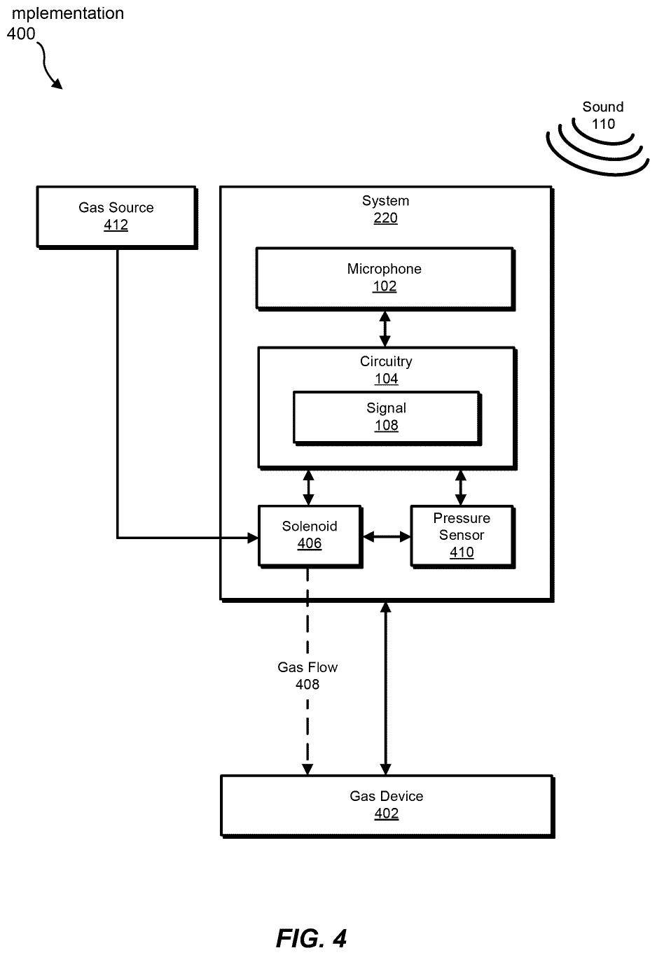

FIG. 4 illustrates an exemplary implementation 400 of system 220 for restoring disabled functionalities of appliances upon mitigating corresponding safety concerns. In some examples, system 220 may include and/or represent certain mechanisms, components, devices, and/or features that perform and/or provide functionalities that are similar and/or identical to those described above in connection with any of FIGS. 1-3. In one example, system 220 may include and/or represent microphone 102, circuitry 104, a solenoid 406, and/or a pressure sensor 410. In this example, system 220 may be deployed and/or implemented in an environment with a gas device 402 and/or a gas source 412.

In some examples, system 220 may be fluidically coupled to gas device 402 via a gas line and/or pipe. For example, solenoid 406 of system 220 may be fluidically coupled to gas device 402. In this example, solenoid 406 of system 220 may be able to control and/or regulate the flow of gas, liquid, and/or fluid between gas source 412 and gas device 402.

In one example, solenoid 406 may provide a test load (e.g., a gas pulse) to gas device 402 to inspect (e.g., via pressure sensor 410 and/or a flow meter) whether gas device 402 is configured and/or activated to draw any gas—and if so, how much—before making a determination on the safety of gas device 402. Additionally or alternatively, pressure sensor 410 may measure and/or determine the amount of pressure within the gas line or connection to infer whether the gas device is configured and/or activated to draw any gas prior to fully restoring the gas connection between gas device 402 and gas source 412. In this example, circuitry 104 of system 220 may compare the amount of gas flow drawn by appliance 202 to a threshold value indicative of the potentially dangerous feature being turned on (e.g., any gas flow at all).

For example, if gas device 402 is configured and/or activated to draw any gas, then circuitry 104 of system 220 may determine that gas device 402 is still unsafe and thus unfit to have the gas restored for one reason or another (e.g., one or more control knobs of gas device 402 are set to an “on” position). However, if gas device 402 is not configured and/or activated to draw any gas, then circuitry 104 of system 220 may determine that gas device 402 is safe and thus fit to have the gas restored (e.g., all control knobs of gas device 402 are set to the “off” position). In this example, upon determining that gas device 402 is safe in this way, circuitry 104 of system 220 may restore a gas flow 408 to gas device 402 via solenoid 406, thereby reenabling gas device 402 for further use.

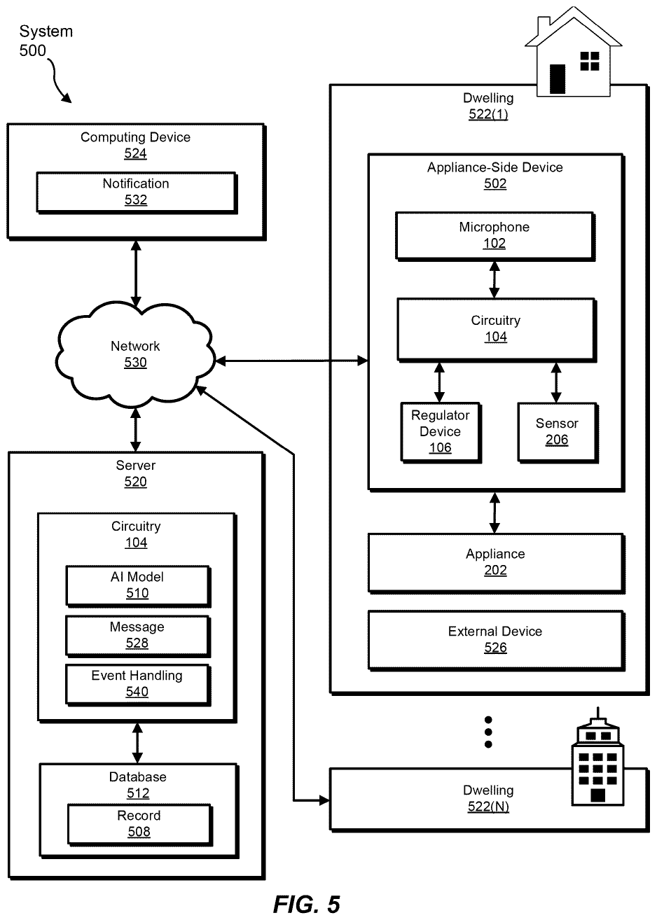

FIG. 5 illustrates an exemplary system 500 for restoring disabled functionalities of appliances upon mitigating corresponding safety concerns. In some examples, system 500 may include and/or represent certain mechanisms, components, devices, and/or features that perform and/or provide functionalities that are similar and/or identical to those described above in connection with any of FIGS. 1-4. In one example, system 500 may include and/or represent a computing device 524, a server 520, and/or multiple appliance-side devices deployed and/or implemented across dwellings 522(1)-(N). In this example, computing device 524, server 520, and/or one or more of the appliance-side devices may be communicatively coupled to one another via a network 530.

In some examples, the appliance-side devices may each constitute and/or represent a smart regulator and/or an instance of apparatus 100. In one example, circuitry 104 may distributed and/or dispersed throughout and/or across various devices included in system 500. For example, some portions of circuitry 104 may be deployed and/or implemented in appliance-side device 502, and other portions of circuitry 104 may be deployed and/or implemented in server 520. In one example, the appliance-side devices and/or server 520 may coordinate with one another and/or work in conjunction with one another to predict which of dwellings 522(1)-(N) are most likely to experience a fire and/or smoke event.

In some examples, the appliance-side devices may include and/or represent an appliance-side device 502 installed and/or applied to appliance 202 in dwelling 522(1). In one example, appliance-side device 502 may include and/or represent microphone 102, circuitry 104, regulator device 106, and/or sensor 206. In certain implementations, regulator device 106 may modify, suspend, and/or disable a functionality or resource of appliance 202 in response to the detection of sound 110 captured by microphone 102. For example, circuitry 104 may recognize, identify, and/or detect a certain pattern, signature, and/or sequence indicative of a smoke and/or fire alarm in sound 110. In response to determining that the smoke and/or fire alarm is beeping and/or blaring, circuitry 104 may direct and/or cause regulator device 106 to suspend, disable, and/or shut off a certain functionality and/or resource of the appliance (e.g., the flow and/or delivery of electricity and/or gas, etc.) for safety reasons.

In some examples, circuitry 104 may be configured to determine that the sound 110 is no longer audible a certain amount of time after regulator device 106 suspends and/or disables the functionality or resource of appliance 202. In one example, if sound 110 is no longer audible after the certain amount of time expires, circuitry 104 may restore the functionality and/or resource of appliance 202. However, in an alternative example, if sound 110 is still audible after the certain amount of time expires, circuitry 104 may refuse to restore the functionality and/or resource of the appliance and may lock the auto-restore mechanism to prevent auto-restoration and/or force a manual reboot by a user. For example, if the auto-restore mechanism is locked, the user may need to press a physical switch and/or button on the appliance to restore the functionality and/or resource.

In some examples, system 500 may monitor and/or track the behaviors, patterns, habits, actions, and/or demographics of the occupants of dwellings 522(1)-(N) to predict which of dwellings 522(1)-(N) are most likely to experience a fire and/or smoke event. For example, occupants may perform and/or exhibit certain behaviors indicative and/or suggestive of fire and/or smoke events occurring in their respective dwellings. In this example, system 500 may observe, detect, and/or extrapolate such behaviors or demographics and/or perform certain actions to mitigate the risks associated with such behaviors or demographics. Examples of such behaviors include, without limitation, high frequency of appliance use, long duration of appliance use, high and/or unsafe settings during appliance use, history of fire and/or smoke events, unattended appliance use, failure to respond to smoke alarms and/or safety notifications, unsafe attempts to manually and/or automatically restore functionalities and/or resources, cumulative risk factors, status of connectivity between the appliance or one of the occupants'mobile devices and a network (e.g., an intranet, a home network, the Internet, etc.), occupancy data (e.g., age, gender, number of occupants, ethnicity, etc.), access to enter the dwelling and/or ability to unlock doors, combinations or variations of one or more of the same, and/or any other risky and/or unsafe behaviors.

In some examples, system 500 may rely on and/or use various devices and/or appliances to collect and/or provide data and/or information about the occupants'behaviors. In one example, in addition to the appliance-side devices and/or the appliances themselves, system 500 may include and/or represent external devices that report certain behavior data and/or information to server 520 for the purpose of identifying and/or predicting those dwellings at high risk of fire and/or smoke events. For example, an external device 526 may be deployed and/or implemented at and/or in dwelling 522(1). In this example, external device 526 may include and/or represent an electronic door lock, a smartphone and/or mobile device of an occupant, a smart smoke alarm, a home security system, a smart household device, and/or a video camera. In certain implementations, external device 526 may generate and/or provide data and/or information indicative of whether occupants are present or away at the time of a fire and/or smoke event.

In some examples, external device 526, appliance-side device 502, and/or appliance 202 may collect and/or generate data and/or information indicative of the behaviors, patterns, habits, and/or actions of the occupants of dwellings 522(1). In one example, external device 526, appliance-side device 502, and/or appliance 202 may transmit and/or provide such data and/or information to server 520 via network 530. In this example, server 520 may store some or all of such data and/or information in a database 512. Additionally or alternatively, server 520 may use and/or rely on such data and/or information to predict which of dwellings 522(1)-(N) are most likely to experience a fire and/or smoke event. Examples of such data and/or information include, without limitation, frequencies of the occupants using certain appliances (e.g., appliance 202), the durations that the occupants use such appliances, the settings (e.g., high temperatures) of such appliances during use, fire-safety events that occur in any of dwellings 522(1)-(N), the number of fire and/or smoke events that occur in each of dwellings 522(1)-(N), combinations or variations of one or more of the same, and/or any other suitable data and/or information.

In some examples, external device 526 may generate and/or produce a message 528 indicating that a user of external device 526 has left his or her dwelling. In one example, external device 526 may transmit and/or provide message 528 to server 520 via network 530. In this example, server 520 may store some or all of message 528 in database 512. Additionally or alternatively, server 520 may use and/or rely on some or all of message 528 to predict and/or estimate the likelihood of the user's dwelling experiencing a fire and/or smoke event.

In some examples, circuitry 104 of server 520 may create and/or make a record 508 indicating the likelihood that appliance 202 was left unattended during use. For example, circuitry 104 of server 520 may analyze and/or evaluate all the data and/or information received from external device 526, appliance-side device 502, and/or appliance 202. In this example, by analyzing and/or evaluating such data and/or information in this way, circuitry 104 of server 520 may be able to determine, infer, and/or extrapolate that the user left appliance 202 unattended during use. Circuitry 104 may then create and/or make record 508 based at least in part on this analysis and/or evaluation.

In some examples, circuitry 104 of server 520 or appliance-side device 502 may implement and/or perform event handling 540 in response to one or more observations, fire and/or smoke events, and/or message 528. For example, if the user leaves a stove on while exiting his or her dwelling, circuitry 104 may perform one or more automated actions in response. In this example, circuitry 104 may turn off the stove, notify the user, notify the user's neighbors, opening or shutting the user's automated blinds, locking or unlocking the user's dwelling, etc.

In some examples, circuitry 104 of server 520 may predict, estimate, and/or compute the likelihoods of dwellings 522(1)-(N) experiencing a fire and/or smoke event based at least in part on database 512. In one example, circuitry 104 of server 520 may then determine and/or identify which of those likelihoods exceed a certain threshold (e.g., 5%, 10%, and/or 15% chance of experiencing a fire and/or smoke event within the next week, month, and/or year, etc.). In this example, circuitry 104 of server 520 may generate and/or produce a notification 532 of such a prediction and/or likelihood.

In some examples, circuitry 104 of server 520 may transmit and/or provide notification 532 to computing device 524 for presentation and/or display to the user. In one example, the user of computing device 524 may be an occupant and/or property manager of one of dwellings 522(1)-(N). In this example, notification 532 may warn and/or advise the user about that one of dwellings 522(1)-(N) being likely to experience a fire and/or smoke event based at least in part on the behaviors, patterns, habits, and/or actions of either the user and/or one or more other occupants.

In certain implementations, circuitry 104 of server 520 may perform one or more actions in response to and/or based at least in part on record 508, message 528, and/or database 512. Examples of such actions include, without limitation, storing record 508 in a database 512, training an artificial intelligence (AI) model with training data that includes record 508, predicting future fires within dwellings 522(1)-(N) based at least in part on record 508, reminding the user to return to appliance 202 because appliance 202 is operational, notifying another user of appliance 202 having been left unattended, combinations or variations of one or more of the same, and/or any other suitable actions.

In some examples, circuitry 104 of server 520 may implement, develop, and/or build an AI model 510 to predict, estimate, and/or compute the likelihoods of dwellings 522(1)-(N) experiencing a fire and/or smoke event. In one example, circuitry 104 of server 520 may train AI model 510 based at least in part on the data and/or information stored in database 512. In this example, circuitry 104 of server 520 may leverage outputs from AI model 510 to predict which of dwellings 522(1)-(N) are most at risk of experiencing a fire. Additionally or alternatively, circuitry 104 of server 520 may notify one or more occupants and/or property managers of such dwellings about those risks.

In some examples, circuitry 104 may implement, utilize, and/or rely on an AI model 510 to perform one or more functions and/or features for restoring disabled functionalities of appliances upon mitigating corresponding safety concerns. In one example, AI model 510 may include and/or represent a machine learning model, feature, and/or algorithm. Examples of AI model 510 include, without limitation, machine learning, neural networks (e.g., feedforward neural networks, convolutional neural networks, recurrent neural networks, etc.), support vector machines, generative AI, AI clustering, decision trees, regression analysis, machine learning classification, variations or combinations of one or more of the same, and/or any other suitable supervised, semi-supervised, or unsupervised AI models.

In some examples, the apparatuses and systems described in connection with FIGS. 1-5 may include and/or represent one or more additional devices, circuits, components, and/or features that are not necessarily illustrated and/or labeled in FIGS. 1-5. For example, the apparatus and systems illustrated in FIGS. 1-5 may also include and/or represent additional network devices, gateways, computing devices, controllers, routers, switches, analog and/or digital circuitry, onboard logic, transistors, transmitters, receivers, transceivers, antennas, resistors, capacitors, diodes, inductors, switches, registers, flipflops, connections, traces, buses, semiconductor (e.g., silicon) devices and/or structures, processing devices, storage devices, circuit boards, sensors, packages, substrates, housings, combinations or variations of one or more of the same, and/or any other suitable components that facilitate and/or support restoring disabled functionalities of appliances upon mitigating corresponding safety concerns. In certain implementations, one or more of these additional devices, circuits, components, and/or features may be inserted and/or applied between any of the existing devices, circuits, components, and/or features illustrated in FIGS. 1-5 consistent with the aims and/or objectives described herein. Accordingly, the couplings and/or connections described with reference to FIGS. 1-5 may be direct connections with no intermediate components, devices, and/or nodes or indirect connections with one or more intermediate components, devices, and/or nodes.

In some examples, the phrase “to couple” and/or the term “coupling,” as used herein, may refer to a direct connection and/or an indirect connection. For example, a direct coupling between two components constitutes and/or represents a coupling in which those two devices or components are directly connected to each other by a single node that provides continuity from one of those two devices or components to the other. In other words, the direct coupling excludes and/or omits any additional devices or components between those two devices or components.

Additionally or alternatively, an indirect coupling between two devices and/or components constitutes and/or represents a coupling in which those two devices or components are indirectly connected to each other by multiple nodes that fail to provide direct electrical and/or communicative continuity from one of those two devices or components to the other. In other words, the indirect coupling includes and/or incorporates at least one additional device or component between those two devices or components.

FIG. 6 is a flow diagram of an exemplary method 600 for restoring disabled functionalities of appliances upon mitigating corresponding safety concerns. In one example, the steps shown in FIG. 6 may be achieved and/or accomplished by a manufacturer of a smart regulator device. Additionally or alternatively, the steps shown in FIG. 6 may incorporate and/or involve certain sub-steps and/or variations consistent with the descriptions provided above in connection with FIGS. 1-5.

As illustrated in FIG. 6, method 600 may include the step of configuring a regulator device to modify a functionality of an appliance in response to detection of a specific sound captured by a microphone (610). Step 610 may be performed in a variety of ways, including any of those described above in connection with FIGS. 1-5. For example, a manufacturer or subcontractor may configure and/or program a regulator device to modify a functionality of an appliance in response to detection of a specific sound captured by a microphone.

Method 600 may also include the step of configuring circuitry to determine, based at least in part on a signal received from the microphone, that the specific sound is no longer audible a certain amount of time after the regulator device modifies the functionality of the appliance (620). Step 620 may be performed in a variety of ways, including any of those described above in connection with FIGS. 1-5. For example, the manufacturer or subcontractor may configure and/or program circuitry to determine, based at least in part on a signal received from the microphone, that the specific sound is no longer audible a certain amount of time after the regulator device modifies the functionality of the appliance.

Method 600 may also include the step of configuring circuitry to restore the functionality of the appliance in response to the specific sound no longer being audible (630). Step 630 may be performed in a variety of ways, including any of those described above in connection with FIGS. 1-5. For example, the manufacturer or subcontractor may configure and/or program to the circuitry restore the functionality of the appliance in response to the specific sound no longer being audible.

As described above in connection with FIGS. 1-5, a system may be configured and/or programmed to automatically restore a disabled functionality and/or resource of an appliance (e.g., a gas device or an electric device). The system may include a microphone, a controller, and/or a power regulator device that is configured to cut power to the appliance upon detecting a blaring smoke alarm. The controller may be configured to determine, based on input signals received from the microphone, whether the smoke alarm is still blaring after a certain amount of time (e.g., two minutes, five minutes, ten minutes, thirty minutes, etc.) has passed since the power to the appliance was cut by the power regulator device.

Then, upon determining that the smoke alarm is no longer sounding and that the certain amount of time has passed, the controller may send a reboot signal to the electric device or to the power regulator device to reboot the electric device. In cases where the device is a gas-powered stove, the systems herein may detect the presence of a gas-regulating solenoid and then send control signals to the solenoid to allow or prevent the flow of gas to the gas-powered stove. In one example, the reboot may occur automatically and may be retried each time the certain amount of time has passed again. In some implementations, the system may include a current sensor, and the controller may communicate with the power regulator device to cut power to the electric device upon detecting at least a threshold amount of current at the current sensor.

Thus, if the current sensor is still sensing a power draw indicating that one of the stove knobs is set to the “on” position, the automatic reboot feature may turn off or be delayed for a specified amount of time during which the knob could be turned off by the user. This embodiment may prevent the stove from being rebooted to an “on” position if one of the knobs is still turned on (which could exacerbate any existing fire-causing conditions). This step of repeatedly measuring current to determine whether a stove knob is still turned on may be performed on a repeated basis until no current is detected or until a specified number of retries has occurred—after which the automatic retries will stop.

In some cases, the power regulator device and/or the controller may store usage data about the stove or other electric device. The usage data may indicate when the stove is used, how long it is used, what time of day the stove is most frequently used, what temperature is most often used, etc. At least in some cases, this usage data may be anonymized and combined with other users'usage data. The usage data may then be analyzed, in conjunction with fire data indicating which dwellings actually experienced a fire or smoke alarm signal, to determine which dwellings are most likely to experience a fire in the future. Some usage data may indicate a likelihood that the electric device was left in an “on” position while being unattended (e.g., by detecting that a user has left their house (e.g., via global positioning system (GPS) data or WiFi geofence data) or by determining that the user has locked an external door from the outside). This prediction and usage data may be stored in a data store and/or sent to one or more entities that use the information to insure dwelling units or to protect the dwelling units from fire.

In some embodiments, the controller or another computing system may be implemented to train a machine learning (ML) model to compute the prediction indicating which dwelling units are most likely to experience a fire. For instance, a ML model may be fed, as input data, stove usage data or other appliance usage data for a plurality of different occupants. The ML model may also be given, as input data, the number of dwellings that experienced fires, smoke, audible smoke alarm signals, etc. These input data may then be used by the ML model to learn which usage patterns are more likely to lead to fires and smoke, and which usage patterns are more benign. The ML model may then use these derived usage patterns to predict which dwelling units are most likely to experience fires or smoke within an upcoming time period.

This prediction may be provided to apartment building owners, homeowners, condominium owners, insurance companies, fire departments, or other entities as part of a software as a service (SAAS) platform. In some cases, the computed prediction may be used by the systems described herein used to control operation of the electric device, including turning off the electric device and/or preventing the electric device from turning on. This operational control may also be affected by other actions performed by a user. For instance, the system may receive an indication, at the controller, that an external door lock associated with a dwelling unit has been locked from the outside. The controller may then determine that the user has left the electric device unattended and may control the device accordingly (e.g., by turning the device off). The controller may also interface with a transmitter to send a notification to the user's mobile device indicating to the user that their stove has been left unattended.

In some examples, if the user returns to the dwelling, unlocking the lock during entry, the user may then hit a button on a standalone device or on a smartphone or other electronic device that emanates a predefined audio tone. The controller and/or the power regulator device may recognize the predefined audio tone and may implement the controller to turn the electric device on or off upon confirming the predefined audio tone. In cases where a standalone device is implemented, the device may have a button and a speaker, as well as a magnet or tap-on bottom that would mount on the side of the stove or on a fridge or other surface.

In some embodiments, a system may be provided that includes a gas device. The gas device (or gas-powered device) includes a gas line, a solenoid that regulates gas through the gas line, and a pressure sensor. The system also includes a microphone, a power regulator device configured to cut gas flow, via the solenoid, to the gas device upon detecting a specified sound, and a controller. The controller may be configured to determine, based on input signals received from the microphone, whether the specified sound is still audible, whether a specified amount of time has passed since gas to the gas device was cut by the intermediate device, and whether the pressure sensor indicates that gas flow has stopped. Then, upon determining that the specified sound is not still present, that the specified amount of time has passed, and that gas flow has stopped, the controller may send a reboot signal to the gas device or to the power regulator device to reboot the gas device.

The pressure sensor may be used to establish a baseline pressure reading that exists when stove knobs are turned off. The pressure sensor may also be used to establish a “stove knobs on” status where at least one of the stove knobs is turned on to some degree. These pressure measurements may then be used to determine whether the gas stove's knobs are turned on prior to rebooting the stove. In some cases, the system may allow the solenoid to open for a few seconds, during which time the pressure sensor would take a reading and see if the gas line pressurizes to the expected baseline (i.e., the expected pressure if all knobs are turned off) within a few seconds. If the expected pressure is reached, the system would know that it is safe to allow the gas solenoid to remain open since the knobs are turned off. On the flipside, if the stove knobs have been left on, the auto-reboot attempt may occur, and the gas line pressure would not reach the expected baseline pressure since the gas line was left open due to the knobs being left on. The system would then know to turn the solenoid back off to ensure no future gas flow continues. A manual reboot and button press may then be required of the user to ensure that the gas is safely restored to the gas stove.

It should be understood that the embodiments described herein may be implemented with substantially any home appliance (e.g., washer, dryer, refrigerator, microwave, dishwasher, or other electric or gas-powered appliance). Moreover, these embodiments may be used with industrial equipment, including manufacturing equipment, machinery, or other devices. Still further, while many of the embodiments described herein listen for audible signals from smoke alarms, it will be recognized that these embodiments may listen for other sounds created by other devices or systems.

The embodiments described herein may implement various types of processors, controllers, or other types of computing systems. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

Computing systems typically include at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

In some examples, all or a portion of apparatus 100 in FIG. 1 may represent portions of a cloud-computing or network-based environment. Cloud-computing and network-based environments may provide various services and applications via the Internet. These cloud-computing and network-based services (e.g., software as a service, platform as a service, infrastructure as a service, etc.) may be accessible through a web browser or other remote interface. Various functions described herein may also provide network switching capabilities, gateway access capabilities, network security functions, content caching and delivery services for a network, network control services, and/or and other networking functionality.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of. ” Finally, for ease of use, the terms “including” and “having” (and their derivatives), as used in the specification and claims, are interchangeable with and have the same meaning as the word “comprising.”

What is claimed is:

1. A system comprising:
a microphone;
a regulator device configured to modify a functionality of an appliance in response to detection of a specific sound captured by the microphone; and
circuitry configured to:
determine, based at least in part on a signal received from the microphone, that the specific sound is no longer audible a certain amount of time after the regulator device modifies the functionality of the appliance; and
restore the functionality of the appliance in response to the specific sound no longer being audible.

2. The system of claim 1, wherein the appliance comprises at least one of:
an electric device that consumes power; or
a gas device that consumes gas.

3. The system of claim 1, wherein the circuitry is further configured to restore the functionality of the appliance by rebooting the appliance due at least in part to the specific sound no longer being audible.

4. The system of claim 1, wherein the circuitry is further configured to restore the functionality of the appliance by rebooting the regulator device due at least in part to the specific sound no longer being audible.

5. The system of claim 1, wherein the regulator device is further configured to modify the functionality by at least one of:
shutting down gas flow to the appliance; or
shutting down electricity flow to the appliance.

6. The system of claim 1, wherein the circuitry is further configured to:
test whether a potentially dangerous feature of the appliance is turned on;
determine, based at least in part on the test, that the potentially dangerous feature of the appliance is not turned on; and
restore the functionality of the appliance due at least in part to the potentially dangerous feature not being turned on.

7. The system of claim 6, further comprising a current sensor configured to measure an amount of current drawn by the appliance, wherein the circuitry is further configured to test whether the potentially dangerous feature of the appliance is turned on by comparing the amount of current drawn by the appliance to a threshold value indicative of the potentially dangerous feature being turned on.

8. The system of claim 6, further comprising a flow meter or pressure sensor configured to measure any gas flow drawn by the appliance, wherein the circuitry is further configured to test whether the potentially dangerous feature of the appliance is turned on by comparing the measurement to a threshold value indicative of the potentially dangerous feature being turned on.

9. The system of claim 1, wherein the circuitry is further configured to:
create a record indicating a likelihood that the appliance was left unattended; and
perform at least one action in connection with the record due at least in part to the appliance having likely been left unattended.

10. The system of claim 9, wherein the action comprises:
storing the record in a database; and
predicting, based at least in part on the database, a dwelling whose likelihood of experiencing a fire exceeds a certain threshold.

11. The system of claim 10, wherein the circuitry is further configured to provide a notification of the prediction about the dwelling to at least one computing device.

12. The system of claim 10, wherein the circuitry is further configured to implement an artificial intelligence (AI) model that provides the prediction about the dwelling based at least in part on the database.

13. The system of claim 12, wherein the circuitry is further configured to train the AI model based at least in part on data representative of behaviors or demographics of occupants of multiple dwellings, the behaviors comprising at least one of:
frequency that the occupants use certain appliances;
duration that the occupants use the certain appliances;
settings of the certain appliances during use;
fire-safety events that occur in any of the multiple dwellings;
number of smoke events that occur in the multiple dwellings;
connectivity between home networks of the multiple dwellings and computing devices of the occupants; or
access to enter doors of the multiple dwellings.

14. The system of claim 12, wherein the circuitry comprises at least one of:
at least one appliance-side circuit communicatively coupled to the appliance; or
a server-side circuit configured to train the AI model.

15. The system of claim 9, wherein the circuitry is further configured to:
receive, from an external device associated with a dwelling where the appliance is located, a message indicating that a user of the external device has left the dwelling; and
perform the action due at least in part to the user having left the dwelling.

16. The system of claim 1, wherein the circuitry is further configured to:
test whether a potentially dangerous feature of the appliance is turned on;
determine, based at least in part on the test, that the potentially dangerous feature of the appliance is turned on; and
refuse to reboot the appliance or the regulator device due at least in part to the potentially dangerous feature being turned on.

17. An apparatus comprising:
a microphone;
a regulator device configured to disable a resource of an appliance in response to detection of a smoke alarm captured by the microphone; and
circuitry configured to:
determine, based at least in part on a signal received from the microphone, that the smoke alarm is no longer audible a certain amount of time after the regulator device disables the resource of the appliance; and
perform at least one action in connection with the resource of the appliance in response to the smoke alarm no longer being audible.

18. The apparatus of claim 17, wherein the appliance comprises at least one of:
an electric device that consumes power; or
a gas device that consumes gas.

19. The apparatus of claim 17, wherein the circuitry is further configured to restore the resource of the appliance by rebooting the appliance due at least in part to the smoke alarm no longer being audible.

20. A method comprising:
configuring a regulator device to modify a functionality of an appliance in response to detection of a specific sound captured by a microphone; and
configuring circuitry to:
determine, based at least in part on a signal received from the microphone, that the specific sound is no longer audible a certain amount of time after the regulator device modifies the functionality of the appliance; and
restore the functionality of the appliance in response to the specific sound no longer being audible.
